(19) United States
(12) Patent Application Publication
(10) Pub. No.: US 2007/0120042 A1
(43) Pub. Date: May 31, 2007

(54) OPTICAL INFORMATION RECORDING-REPRODUCTION APPARATUS

(75) Inventor: Koichiro NISHIKAWA, Takasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/560,101

(22) Filed: Nov. 15, 2006

(30) Foreign Application Priority Data
Nov. 29, 2005 (JP) 2005-343880

(51) Int. Cl. G02B 7/04

(52) U.S. Cl. 250/201.5

(57) ABSTRACT

A collinear system optical information recording-reproduction apparatus is provided which gives sufficiently high interference modulation degree even with inexpensive semiconductor laser as the recording-reproduction light source. Specifically in this apparatus, recording is conducted by introducing a light flux from a light source to a spatial light modulator having an information pattern area and a reference pattern area, introducing the produced information light and reference light to object lens to record the information to a recording medium by the object lens by holography; and reproduction is conducted by projecting the reference light only from the spatial light modulator to the recording medium, and introducing the light reflected by the recording medium to a light-receiving element. In this apparatus the average information light intensity and the average reference light intensity introduced into the object lens are made equal.

### BACKGROUND OF THE INVENTION

1. Field of the Invention

The present invention relates to an optical information recording-reproduction apparatus. In particular, the present invention relates to an optical information recording-reproduction apparatus which utilizes holography for recording information on a recording medium and reproducing the recorded information from the recording medium.

2. Description of the Related Art

In information recording by holography on a recording medium, a light beam carrying image information (information light) and a light beam for reference (reference light) are superposed in a recording medium and the formed interference fringes (hologram) are written in the recording medium. In reproducing the information, a reference light beam is projected onto the recording medium to reproduce the image information by diffraction caused by the interference fringes. In recent years, a holographic memory is attracting attention for practical use as an ultra-high-density data storage. In particular, an optical disk memory is attracting attention which records image information or the like developed two-dimensionally, by utilizing holography on a disk-shaped recording medium like a CD and a DVD, and reproducing the information from the recording medium.

For example, recording-reproduction apparatuses employing a collinear type holographic memory which utilize the above technologies are disclosed in the following two documents: Proceedings of 35ₜₕ Meeting on Light Wave Sensing Technology, June, 2005, pp.75-82 “Holographic Memory/Measurement & Nano Control Technologies for Blostering HVD™”; and NIKKEI ELECTRONICS, 2005.1.17., pp.105-114 “Holographic Medium Will Achieve 200G Bytes in 2006”.

In this system characteristically, the information light and the reference light are generated by one and the same spatial light modulator, and the two light fluxes are allowed to travel along the same optical axis, and are focused on a recording medium by an object lens to record the information as a hologram. In reproduction of the information in this system, only the reference light flux generated by the spatial light modulator is focused on the recording medium carrying the information, and the information light is reproduced by diffraction caused by the hologram.

The spatial light modulation pattern for generating the information light and the reference light has the center region for generating the information light and the peripheral region for generating the reference light. According to the document: OPTICAL REVIEW vol. 12 No. 2(2005) pp. 90-92 “Advanced Collinear Holography”, the spatial light modulation pattern has roughly a constitution shown in FIGS. 2A and 2B.

FIG. 2A illustrates schematically information pattern area 21 and reference pattern area 22 of the modulation pattern within the effective light flux diameter (corresponding to the incident light flux diameter). Actually, the reference pattern area in the spatial light modulator is made larger than the area of radius r3 in consideration of the tolerable positional deviation. In FIG. 2B, information pattern area 21 is a circular area of radius r1, and reference pattern area 22 is an annular area between a circle of a radius r2 and a circle of a radius r3. The ratio of the radiuses is approximately as below: r1:r2:r3≈60:70:100.

The above system has disadvantages that, when the light source such as a semiconductor laser having Gauss-distributed light intensity is employed for the recording-reproduction, the light including the tailing portion of the light intensity distribution needs to be utilized necessarily for securing the intensity for the recording.

FIG. 3 shows schematically distribution 23 of the intensity of a light flux introduced into spatial light modulator 4. The broken lines show diameter D of the light flux on the spatial light modulator corresponding to light flux introduced into the object lens. As understood from FIG. 3, in a collinear system, the information light derived from central portion of the spatial light modulator has a higher intensity, whereas the reference light derived from the peripheral portion of the spatial light modulator has a lower intensity. Therefore, the intensity difference can be caused between the information light and the reference light.

Generally, the brightness/darkness modulation degree of light interference is maximal when the interfering light beams have an equal intensity. Therefore, the brightness/darkness modulation degree in the recorded hologram is lower when the intensity is different between the interfering light beams. This can lower the S/N ratio of the signals reproduced from the hologram undesirably.

### SUMMARY OF THE INVENTION

To solve the above problem, the present invention intends to obtain satisfactory modulation degree of the interference with an inexpensive laser light source as the recording-reproduction light source.

According to an aspect of the present invention, there is provided a collinear system optical information recording-reproduction apparatus, comprising a laser light source, a spatial light modulator having an information pattern area for generating information light and a reference pattern area for generating reference light, an object lens for introducing the information light and the reference light to a recording medium for recording information on the recording medium by holography, and a light-receiving element for receiving reflected light obtained by projecting only the reference light to the recording medium, for reproducing the information, wherein average intensity of the information light and average intensity of the reference light introduced to the object lens are equal to each other.

The laser light source is preferably a semiconductor laser.

The spatial light modulator preferably comprises liquid crystal devices.

In the optical information recording-reproduction apparatus, polarization directions in the information pattern area and the reference pattern area are preferably rotated by adjusting an applied voltage between electrodes in the information pattern area and the reference light area. Further, the ratio of the area of the information pattern area to the area of the reference pattern area is preferably designed to make equal the quantity toward the object lens of the information light to that of the reference light.

The spatial light modulator is preferably a deformable or digital mirror device.

According to the present invention, with a laser light source, the average intensities of the information light and of the reference light derived from a spatial light modulator can be made equal. This enables sufficient modulation degree of interference even with an inexpensive light source like a semiconductor laser to provide an optical information recording-reproduction apparatus at a low cost with a high performance.

Further features of the present invention will become apparent from the following description of exemplary embodiments with reference to the attached drawings.

### BRIEF DESCRIPTION OF THE DRAWINGS

FIG. 1 illustrates optical paths in the optical information recording-reproduction apparatus of the first embodiment.

FIGS. 2A and 2B are schematic drawings of a spatial light modulator.

FIG. 3 is a schematic drawing of an intensity distribution of an introduced light flux in the spatial light modulator.

### DESCRIPTION OF THE EMBODIMENTS

Embodiments of the present invention are described in detail by reference to drawings.

### Embodiment 1

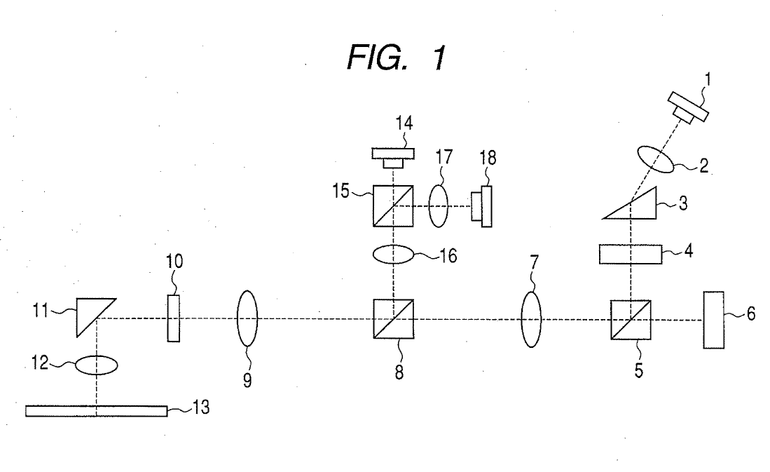

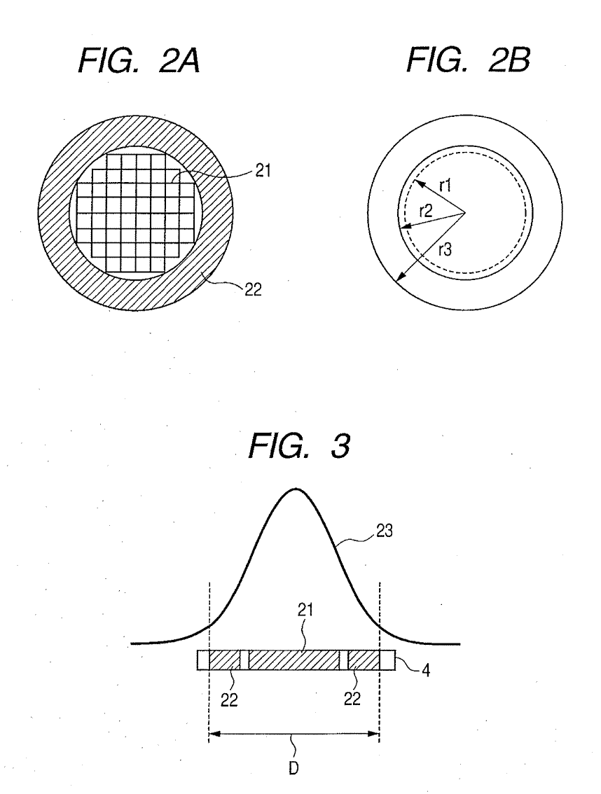

FIG. 1 illustrates optical paths in the optical information recording-reproduction apparatus of the first embodiment of the present invention. FIGS. 2A and 2B are schematic drawings of a spatial light modulator. FIG. 3 is a schematic drawing of an intensity distribution of an introduced light flux in the spatial light modulator.

This embodiment provides an optical information recording-reproduction apparatus employing a collinear type holographic memory.

Firstly, the optical paths for information recording are explained. The light flux emitted from violet LD (laser diode) 1, a semiconductor laser, as the recording-reproduction light source, is converted by collimator 2 into a parallel light flux, enlarged in the direction of minor axis of the ellipsoid to be circular by beam-shaping prism 3, and introduced into spatial light modulator 4.

The light emission pattern of violet LD 1 has a full angle at the half maximum of θ_{//} of 8° in the direction parallel to the paper sheet face direction of FIG. 1, and θ₁₃ of 20° in the direction perpendicular to the paper face direction of FIG. 1. Beam-shaping prism 3 is capable of magnifying the angle θ_{//} by a factor of 2.5. Thereby the intensity distribution in the light flux is approximated by an isotropic Gauss distribution: the distribution is as shown in FIG. 3 in any direction in the cross-section.

Spatial light modulator 4 comprises liquid crystal devices. The respective picture elements input information to the introduced light flux by changing selectively the polarization direction by a predetermined angle by utilizing the optical rotatory power of the liquid crystal for selective reflection of the light by polarization beam splitter 5. Spatial light modulator 4 has information pattern area 21 and reference pattern area 22 as shown schematically in FIG. 2A. The areas are designed to have the parameters of r1, r2, and r3 as shown in FIG. 2B in the ratio of r1:r2:r3≈60:70:100, as in conventional modulators. The two areas generate simultaneously the information light and the reference light.

The recording light flux composed of the information light and the reference light is allowed to pass through polarization beam splitter 5 and a pair of relay lenses (first relay lens 7 and second relay lens 9), and is converted from linearly polarized light to circularly polarized light by ¼-wavelength plate 10. In the recording, the recording light flux passes through dichroic beam splitter 8 and is deflected by mirror 11 to be projected through object lens 12 onto hologram disk 13, a recording medium. In hologram disk 13, the information light and the reference light are allowed to interfere and the resulting hologram is recorded.

Hologram disk 13 is constructed of a transparent substrate, a recording layer which absorbs violet light and transmits red light, and a reflection layer, the layers being arranged in the named order from the light introduction side, although not shown in the drawing. The above-mentioned hologram is recorded in the recording layer. Hologram disk 13 is rotated on the disk rotation axis by a driving means.

The light flux has the intensity in nearly isotropic distribution 23 after adjustment by the above beam-shaping prism 3. The light flux is adjusted to have its diameter at a position of 1/e² of the maximum intensity in superposition on the pupil of object lens 12.

In the information reproduction process, the reproducing light flux behaves basically in the same manner as in the information recording process, except that, in the information reproduction, only the pattern of the reference light is formed by spatial light modulator 4. In the information reproduction, information pattern area 21 may be masked. The reference light projected onto hologram disk 13, is diffracted by the recorded hologram to generate reproduction light carrying the information of the hologram.

This reproduction light is converted to a parallel light flux by object lens 12, and further converted by ¼-wavelength plate 10 to linearly polarized light directed perpendicular to the light projected to hologram disk 13. Thereafter, the reproduction light travels reversely along the optical path of the light projection through polarization beam splitter 5 to CMOS sensor 6 to reproduce the information. In this process, of the reproduction light, peripheral portion of the light which has not contributed the diffraction is intercepted not to enter CMOS sensor 6.

For reading a servo signal or an addressing signal, a light flux is emitted from a red LD 14, a light source, for reading the servo signal or the addressing signal. The light flux passes through polarization beam splitter 15 and coupling lens 16, and is reflected by dichroic beam splitter 8, and is then allowed to pass through relay lens 9. The transmitted light flux becomes a nearly parallel light flux. The light flux passes through ¼-wavelength 10 to be deflected by mirror 11, and is projected through object lens 12 to hologram disk 13.

The light flux reflected by the reflection layer of hologram disk 13 carries information for reading the servo signal or the addressing signal. This light flux travels reversely along the same optical path, and is reflected by polarization beam splitter 15. The reflected light flux travels through sensor lens 17 to PD (photodiode) 18, a light element for receiving a servo signal or an addressing signal to reproduce the servo signal or the addressing signal.

Next, the information light intensity and the reference light intensity are considered. The intensity distribution in the light flux having passed through beam-shaping prism 3 is regarded as a Gauss distribution as shown in FIG. 3. The radius of the pupil of object lens 12 is regarded to be equal to the radius r3 shown in FIG. 2B. Then, in spatial light modulator 4, the intensity (Ii) of the light flux at information pattern area 21 and the intensity (Ir) at reference pattern area 22 introduced from beam-shaping prism 3 are at a ratio of Ii:Ir≈1.0:0.47 or thereabout.

Therefore, information pattern area 21 and reference pattern area 22 have respectively a prescribed pattern, and not all the light beams from all of the picture elements travel through spatial light modulator 4 to reach object lens 12. However, in average, the light from the respective area can be regarded to reach the object lens 12 at a light quantity ratio of about 1.0:0.47. In consideration as one light beam, the brightness/darkness ratio is about 3.2, the modulation degree of interference being low. In this state, the S/N ratio of the reproduced signal is low which is derived from the hologram having formed by interference in hologram disk 13.

Therefore, in this Embodiment, the apparent transmittance of information pattern area 21 is lowered to about half to make equal the quantity of light transmitted through information pattern area 21 to objective lens 12 and the quantity of light transmitted through reference pattern area 22 to objective lens 12. (Herein, the term “equal” signifies that a relative quantity is within the range of ±20%. The same is true in the description below.)

In this Embodiment, the light flux from beam-shaping prism 3 is P-polarized. Polarization beam splitter 5 reflects S-polarized light component toward object lens 12. Therefore, the interelectrode voltage applied to the liquid crystal devices is changed for the areas to rotate the polarization direction by 90° in reference pattern area 22 to introduce the light to object lens 12, whereas, in information pattern area 21, the polarization direction is rotated by about 45°.

Otherwise, to decrease the apparent transmittance of information pattern area to about ½, an ND filter (neutral density filter) may be placed on the liquid crystal devices, or the ND filter may be placed in the optical path of the parallel light flux before polarization beam splitter 5. However, it can cause cost-up, so that the aforementioned system is employed in this embodiment.

In the aforementioned system, regarding the S-polarization component, in the information pattern area 21, the efficiency of reflection at polarization beam splitter 5 is about half of that in reference pattern area 22. In such a manner, the transmittance of the information light from information pattern area 21 to object lens 12 and the transmittance of the reference light from the reference pattern area 22 to object lens 12 can be adjusted.

By this adjustment, the quantity of the light transmitted from information pattern area 21 to object lens 12 and the quantity of the light transmitted from reference pattern area 22 to object lens 12 can be made equal. Therefore the ratio of the brightness to the darkness can be made comparable to (Bright)/(Dark)≈∞, and the modulation degree of the interference can be raised. Thereby, the S/N ratio of reproduction signal derived from the hologram formed by interference in hologram disk 13 can be increased.

In the embodiment illustrated in FIG. 1, spatial light modulator 4 comprises transmission type liquid crystal devices. Otherwise, the spatial light modulator may be of a reflection type in which a mirror is additionally used to reflect the light flux introduced from beam-shaping prism 3. The reflective type spatial light modulator may be a DMD (deformable mirror device, or digital micro-mirror device). In this DMD, without use of an ND filter, the rotation of the polarized light cannot be utilized. In such a case, the reflectivity of the DMD is changed positively between information pattern area 21 and reference pattern area 22.

As described above, according to this embodiment, sufficient interference modulation degree can be achieved by adjusting the information light intensity and the reference light intensity to be nearly equal even with an inexpensive recording-reproduction light source like a semiconductor laser.

### Embodiment 2

In this embodiment, the optical information recording-reproduction apparatus has the same optical paths as that shown in FIG. 1.

In this Embodiment, the area ratio of the information pattern area 21 and reference pattern area 22 in the effective light flux is made different from that of Embodiment 1. Specifically, the ratio of radiuses r1, r2, and r3 is changed to r1:r2:r3=47:57:100.

Thereby, in spatial light modulator 4, the intensity (Ii) of the light flux at information pattern area 21 and the intensity (Ir) at reference pattern area 22 introduced from beam-shaping prism 3 are at a ratio of Ii:Ir≈1.0:1.0.

As the results, the quantity of the light transmitted through information pattern area 21 to objective lens 12 and the quantity of the light transmitted through reference pattern area 22 to object lens 12 are made equal to each other. Therefore, ratio of the intensities of the brightness to the darkness can be made comparable to (Bright)/(Dark)≈∞, and the modulation degree of the interference can be raised. Naturally, in this Embodiment, the efficiency of the light transmission from spatial light modulator 4 to objective lens 12 is uniform within the light flux.

Practically, the ratio of the parameters shown in FIG. 2B is in the range of r1:r2:r3=(45 to 50):(55 to 60):100.

Specifically, at r1:r2:r3=45:55:100, (Bright):Dark)≈9.5; at r1:r2:r3=50:60:100, (Bright):(Dark)≈17.2. Thus the interference modulation degree can be sufficiently high.

From the above, with a semiconductor laser as the light source, the radius of the information pattern area is preferably about half the radius of the effective light flux at the spatial light modulator.

Embodiment 2 can be conducted more readily than Embodiment 1, since only the range of the information pattern area is to be adjusted. As described above, according to this Embodiment, sufficiently high interference modulation degree can be achieved even with inexpensive semiconductor laser as the recording-reproduction light source by making approximately equal the intensities of the information light and the reference light.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2005-343880 filed on Nov. 29, 2005, which is hereby incorporated by reference herein.

What is claimed is:

1. A collinear system optical information recording-reproduction apparatus, comprising
a laser light source,
a spatial light modulator having an information pattern area for generating information light and a reference pattern area for generating reference light,
an object lens for introducing the information light and the reference light to a recording medium for recording information on the recording medium by holography, and
a light-receiving element for receiving reflected light obtained by projecting only the reference light to the recording medium, for reproducing the information,
wherein average intensity of the information light and average intensity of the reference light introduced to the object lens are equal to each other.

2. The collinear system optical information recording-reproduction apparatus according to claim 1, wherein the laser light source is a semiconductor laser.

3. The collinear system optical information recording-reproduction apparatus according claim 1, wherein the spatial light modulator comprises liquid crystal devices.

4. The collinear system optical information recording-reproduction apparatus according to claim 3, wherein polarization directions in the information pattern area and the reference pattern area are rotated by adjusting an applied voltage between electrodes in the information pattern area and the reference pattern area.

5. The collinear system optical information recording-reproduction apparatus according to claim 3, wherein the ratio of the area of the information pattern area to the area of the reference pattern area is designed to make equal the quantity toward the object lens of the information light to that of the reference light.

6. The collinear system optical information recording-reproduction apparatus according to claim 1, wherein the spatial light modulator is a deformable or digital mirror device.
